(19) United States
(12) Patent Application Publication
(10) Pub. No.: US 2008/0228986 A1
(43) Pub. Date: Sep. 18, 2008

(54) ARCHITECTURE FOR CONTROLLING PERIPHERAL DEVICES

(76) Inventor: Luca Lodolo, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/684,922

(22) Filed: Mar. 12, 2007

(51) Int. Cl. G06F 13/20

(52) U.S. Cl. 710/313

(57) ABSTRACT

A peripheral component interface device capable of being removably coupled to an input-output interface in a computer, and at least one peripheral device is described. The peripheral component interface device includes a first communication bus configured to be removably coupled to the input-output interface associated with the computer, a second communication bus configured to be removably coupled to the input-output interface associated with the computer, and a signal regulation circuit electrically coupled to the first communication bus and the second communication bus. In one embodiment, the signal regulation circuit is responsive to commands from the second communication bus to control a signal from the first communication bus passing to the at least one peripheral device, when the at least one peripheral device is coupled to the peripheral component interface device.

### BACKGROUND

Recent technologies have been developed to change the way data are sent within a desktop computer in order to increase speed and efficiency. For example, Universal Serial Bus (USB), Serial ATA (advanced technology attachment), and IEEE 1394 (e.g. FIREWIRE), have been developed as an alternative to traditional parallel data transmission formats to provide for improved bandwidth and future scalability.

The peripheral component interconnect (PCI) bus has been widely used as a general purpose IO interconnect standard over the last several years. PCI standards have been extended to further accommodate the increasing data transfer rate demands of computers. For example, PCI standards have included updates such as accommodating wider data words size and increasing clock speeds. Unfortunately, such updates have fallen short of meeting the rapidly increasing bandwidth demands of computers. In order to meet such increasing data rate demands, industry has developed the 3rd Generation IO, or 3GIO standard. The 3GIO standard has been recently renamed PCI Express.

PCI Express is a serial connection that carries data in packets, similar to the way data is transferred over Ethernet connections. PCI Express bus is an assembly of serial, point-to-point wired, individually clocked ‘lanes’ each consisting of two pairs of data lines carries data upstream and downstream. Each of these lanes is capable of a 2.5 Gb/s data rate in each direction. The overall sustained transfer rate roughly equals 250 MB/s.

Unfortunately, due to varying computer BIOS configurations and peripheral connection standards, peripheral devices connected to a PCI express bus generally do not operate the same, or at all, when the peripheral devices are connected to the PCI express bus when the computer is already turned on, versus when the peripheral devices are connected to the PCI express bus when the computer is turned off, and then recognized during a boot phase when the computer is turned on. In other words, the PCI express bus does not offer consistent plug-and-play compatibility.

Therefore what is needed is a simpler, more efficient and flexible system and method for providing plug-and-play capability for devices connected over a PCI express interface that is simple to integrate with existing computer systems.

Embodiments of the invention address these and other problems, individually and collectively.

### BRIEF SUMMARY

Embodiments of the invention are directed to peripheral component interface devices and methods of providing plug-and-play capability to peripheral devices employing such peripheral component interface devices to connect to a computer. In a broader sense, a peripheral component interface device according to an embodiment of the invention can be removably coupled to a computer via an input output interface and at least one peripheral device. The peripheral component interface device can receive a first signal and a second signal from the computer. The second signal may be used to control the first signal to produce a third signal which can be used by the at least one peripheral device.

In one embodiment, the present invention provides a method of establishing communication between an input output interface in a computer and at least one peripheral device using a peripheral component interface device. The peripheral component interface device includes a first communication bus, a second communication bus, and a signal regulation circuit operatively coupled to the first communication bus and the second communication bus. The method includes coupling the peripheral component interface device to the computer and the at least one peripheral device, and receiving a first signal from the first communication bus and a second signal from the second communication bus, and controlling the signal from the first communication bus using the second signal from the second communication bus and the signal regulation circuit to establish a third signal which passes to the at least one peripheral device.

In one embodiment, the present invention provides a system for establishing communication between a computer and at least one peripheral device. The system includes a processor, and a computer readable storage medium coupled to the processor. The computer readable storage medium includes code for receiving a first signal from the first communication bus and a second signal from the second communication bus, and controlling the first signal from the first communication bus using the second signal from the second communication bus and the signal regulation circuit to establish a third signal which passes to the at least one peripheral device.

These and other embodiments of the invention are described in further detail below.

### BRIEF DESCRIPTION OF THE DRAWINGS

FIG. 1 is a high-level component view illustrating a peripheral device and computer connected via a peripheral component interface device in accordance with embodiments of the invention;

FIG. 2 is a high-level block diagram of a system illustrating a peripheral device connected to a computer via a peripheral component interface device in accordance with embodiments of the invention;

FIG. 3 is a high-level block diagram of a computer memory in accordance with embodiments of the invention;

FIG. 4 is a high-level block diagram of a peripheral component interface device in accordance with embodiments of the invention;

FIG. 5 is a high-level system diagram illustrating a peripheral component interface device in accordance with embodiments of the invention;

FIG. 6 is a high-level flow diagram of a method of operating a peripheral component interface device in accordance with embodiments of the invention; and

FIG. 7 is a high-level flow diagram of a method of communicating with and configuring a peripheral device in accordance with embodiments of the invention.

### DETAILED DESCRIPTION OF EXEMPLARY EMBODIMENTS

Embodiments of the present invention provide for a peripheral component interface device configured to provide plug-and-play capability to peripheral devices employing the peripheral component interface device when connecting to a computer. In one embodiment, the peripheral component interface device includes a peripheral component interface bus and a connection to the computer's USB bus. The peripheral component interface device may include a processor controlled by a client side program communicating with the peripheral component interface device over the USB bus. The processor is employed to control the peripheral device by controlling data and power signals transmitted between the computer and the peripheral device.

The peripheral component interface device may take the form of a port replicating apparatus or may be a part thereof. A number of port replicating apparatuses exist. A “port replicator” is a device containing common PC ports, such as serial and parallel ports. A cable can be used to mechanically and electrically couple a port replicator to a notebook computer. It allows one to easily attach a portable computer to standard, non-portable devices or peripheral devices such as printers and monitors. For example, if one uses a notebook computer both at home and at work, one could set up both work areas with corresponding port replicators. Desired peripheral devices such as printers and monitors may be connected to the port replicators. Then, one would just plug in the notebook computer into a port replicator at either location so that one is able to work with peripheral devices at either work or at home using the notebook computer. Most notebook computer manufacturers offer port replicators as an additional options. Examples of port replicators are described in U.S. Patent Application Nos. 60/824,039 filed on Aug. 30, 2006 and 11/614,776 filed on Dec. 21, 2006, which are herein incorporated in their entirety for all purposes.

A port replicator is similar to a “docking station”. A docking station is another type of port replicating apparatus. Compared to a typical port replicator, a docking station provides additional slots or ports for adding expansion boards and storage devices.

The peripheral component interface device may include a PCI Express bus or any other PCI-type bus, among other buses. PCI Express standard provides a scalable, high speed, serial IO bus that maintains backward compatibility with PCI applications and drivers. A PCI Express architecture has a topology which contains a host bridge and several endpoints (the IO devices). Compared to the older PCI (peripheral component interface) standard, the PCI Express architecture has multiple point-to-point connections and introduces a new element, the switch, into the IO system topology. The switch replaces the multi-drop parallel bus PCI technology and is used to provide fan-out for the IO bus. A switch may provide peer-to-peer communication between different endpoints and this traffic, if it does not involve cache-coherent memory transfers, need not be forwarded to the host bridge. The switch can be a separate logical element, or it could be integrated into a host bridge component. A PCI Express interface or PCI connector may thus be adapted for use with a switching, serial bus architecture.

PCI Express cards have also been developed and are used in conjunction with PCI Express interfaces. Current PCI standard and low-profile cards are used in a variety of platforms, including servers, workstations, and desktops. PCI Express also defines standard and low-profile cards that can replace or coexist with legacy PCI cards. These cards have the same dimensions as PCI cards and are equipped with a rear bracket to accommodate external cable connections. The differences between the PCI and PCI Express cards lie in their IO connectors. A ×1 PCI Express connector has 36 pins, compared to the 120 pins on a standard PCI connector.

PCI Express cards include ExpressCard modules, which currently have two different module widths: 34 mm and 54 mm. ExpressCard modules can be plugged into an external ExpressCard slot in a portable computer or the like, just as PC Cards are used today.

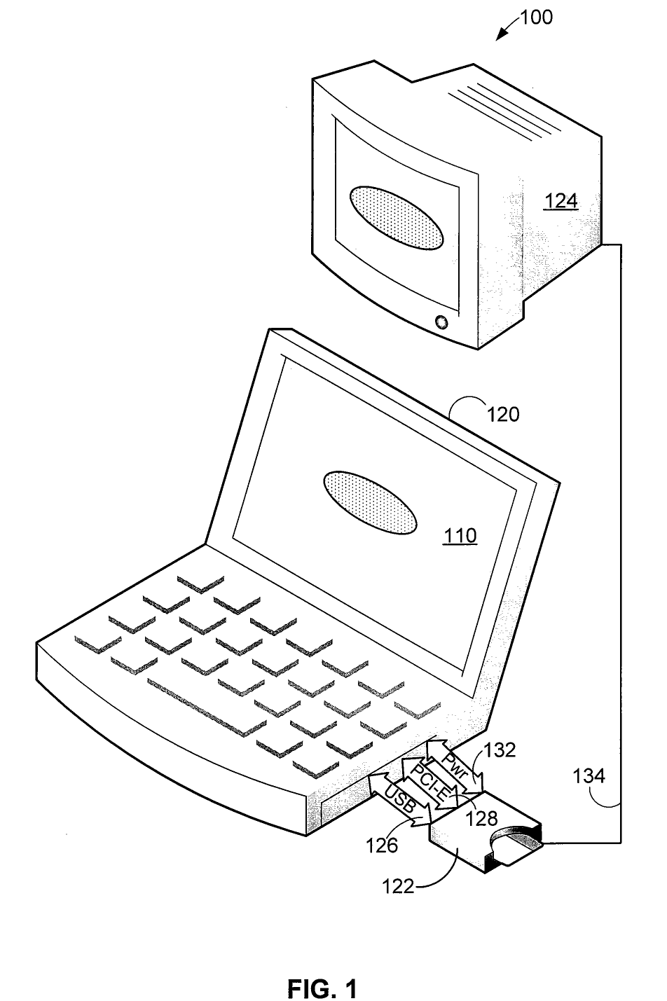

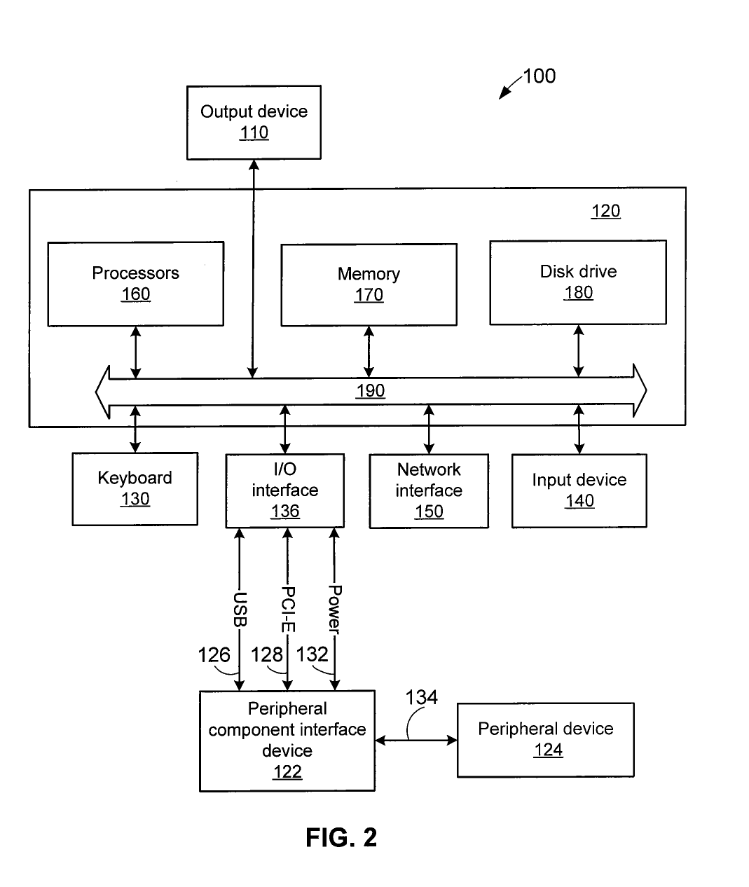

FIG. 1 is an illustration of a system 100 and FIG. 2 is block diagram of the system 100. System 100 depicted in FIG. 1 is merely illustrative of an embodiment incorporating the present invention and is not intended to limit the scope of the invention as recited in the claims. One of ordinary skill in the art would recognize other variations, modifications, and alternatives.

In one embodiment, system 100 includes a computer 120 electrically coupled to a peripheral device 124 via a peripheral component interface device 122, which is described in further detail below. The computer 120 and the peripheral device 124 may be removably coupled to the peripheral component interface device 122, using cables or other types of removable connectors. Peripheral device 124 may be any suitable peripheral device such as a monitor, external hard drive, DVD player, projection unit, printer, mouse, etc. For example, as illustrated in FIG. 1, peripheral device 124 may be a secondary monitor for the computer 120 providing the same or similar display output as an output display device 110 described below.

Computer 120 generally includes an output device 110 such as a monitor, a keyboard 130, a user input device 140, a network communication interface 150, etc. In one embodiment, user input device 140 is typically embodied as a computer mouse, a trackball, a track pad, wireless remote, and the like. User input device 140 typically allows a user to select objects, icons, text and the like that appear, for example, on the output device 110.

Computer 120 typically includes familiar computer components such as a processor 160, and memory storage devices, such as a memory 170, e.g., random access memory (RAM), disk drives 180, and system bus 190 interconnecting the above components. In one embodiment, computer 120 is a PC compatible computer having multiple microprocessors. While a computer is shown, it will be readily apparent to one of ordinary skill in the art that many other hardware and software configurations are suitable for use with embodiments of the present invention.

Memory 170 and disk drives 180 are examples of tangible media for storage of data, audio/video files, computer programs, and the like. Other types of tangible media include floppy disks, removable hard disks, optical storage media such as CD-ROMS and bar codes, semiconductor memories such as flash memories, read-only-memories (ROMS), battery-backed volatile memories, USB drives, networked storage devices, and the like. Any of these can embody a computer readable medium which can comprise code for performing any of the functions described in this application.

Embodiments of network interface 150 typically include an Ethernet card, a modem (telephone, satellite, cable, ISDN), (asynchronous) digital subscriber line (DSL) unit, and the like. Network interface 150 is typically coupled to a communication network, such as the Internet, or to one or more data storage locations such as a web server that may be located outside of the system. In other embodiments, network interface 150 may be physically integrated on the motherboard of computer 120, may be a software program, such as soft DSL, or the like.

In one embodiment, computer 120 may be electrically coupled to peripheral component interface device 122 to provide a communication path between computer 120 and peripheral device 124. For example, computer 120 may be electrically connected to peripheral component interface device 122 through an IO interface 136. IO interface 136 may comprise any suitable interface connection such as a PCI express interface. Such IO interface 136 may also include other interfaces such as a serial interface, a power signal interface, a parallel interface, IEEE 1394 interface, a USB interface and the like. The various interfaces may be embodied by connection ports that can connect to removable connectors such as cables or the like. In some cases, the connection ports may be directly built into the computer 120 or may be present in a card that is inserted into the computer 120.

In one preferred embodiment, IO interface 136 may include a USB interface, PCI interface, and a power signal interface, and one or more of these interfaces could be embodied by a card or the like. The USB interface, PCI interface, and power signal interface may be considered sub-interfaces to the IO interface 136 in some cases, or may be separate from each other. Signals such as data signals, control signals, and/or power signals may be provided from the computer 120 to the peripheral component interface device 122 via the signal IO interface 136. For example, as shown in FIG. 2, computer 120 may be electrically coupled to peripheral component interface device 122 via USB bus 126, PCI (or PCI express) bus 128, and power signal bus 132.

Peripheral component interface device 122 processes such data signals and/or power signals from the computer 120 so that they can be used by the peripheral device 124. In one example, a first signal such as a PCI express signal is transmitted over the PCI express bus 128 and is received by the peripheral component interface device 122. A second signal such as a USB signal is transmitted over the USB bus 126 to the peripheral component interface device 122. The peripheral component interface device 122 then produces a third signal (which could be a PCI Express data or control signal and/or a configuration signal), which may be sent to the peripheral device 124 via paths 134 for data and control signals and/or for controlling power to the peripheral device 124. The third signal may produced by using a signal regulation circuit. The signal regulation circuit may use the second signal (e.g., the USB signal) to control the first signal (e.g., the PCI express signal) to produce the third signal (e.g., a modified PCI express signal).

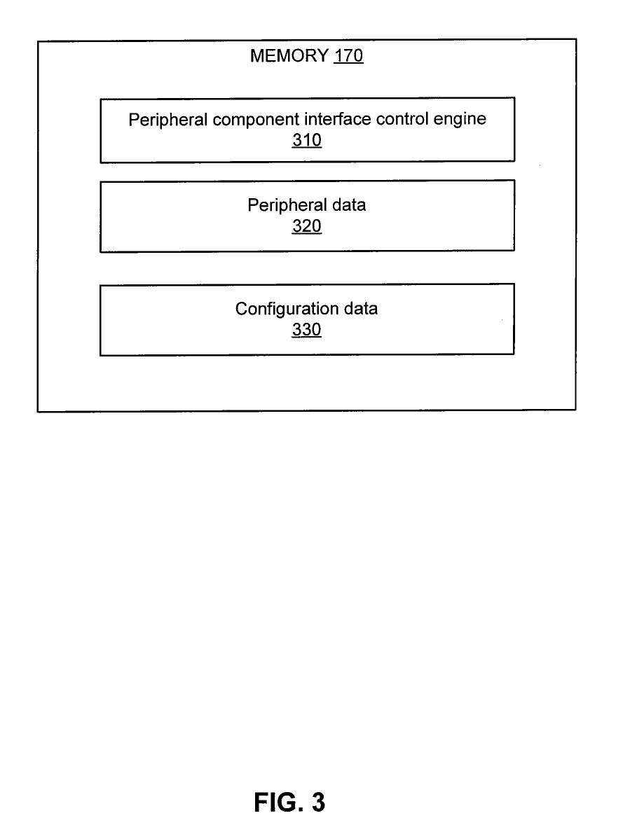

FIG. 3 is a high-level illustration of memory 170 which includes a peripheral component interface engine 310, peripheral data 320, and configuration data 330. As described further below, peripheral component interface control engine 310 is a software engine that facilitates a user or program communicating with and controlling one or more peripheral devices 124 over a PCI express bus such as PCI express bus 128. Peripheral component interface engine 310 may be a stand alone program, may be a plug-in program used to modify and enhance the operation of other programs, or may be incorporated as part of source code for other programs. For example, peripheral component interface engine 310 may be configured to be incorporated into, operate in conjunction with, or modify the operation of software used to communicate with and/or control peripheral devices 124, such as USB control software.

In one embodiment, peripheral data 320 may be any suitable device data or programs related to peripheral device 124 such as device type, model, serial number, data rates, operational modes, communication protocols, device drivers, access protocols, and the like, however, embodiments of the present invention are not so limited. As will be described below, peripheral data 320 may be stored in any suitable location such as memory 170, disk drives 180, and the like.

Configuration data 330 may be any suitable data employed to configure, communicate with and/or control the operation of one or more peripheral device 120. For example, configuration data 330 may be data that determines if peripheral device 120 requires a reboot sequence in order to operate when connected to computer 120, when the computer is operating. Configuration data 330, may also include data related to power signals 132 required by peripheral device 120.

Although the engine 310, peripheral data 320, and configuration data 330 reside in the memory 170 in this example, such components could reside in any other suitable location in other embodiments of the invention.

In one embodiment, configuration data 330 may be used to control peripheral devices 124 independent of computer 120. For example, configuration data 330 may provide sleep data to put peripheral device 124 to sleep after a predetermined period of inactivity, may be used to “wake up” peripheral device 124, or may be used to activate any number of functions available to peripheral device 124.

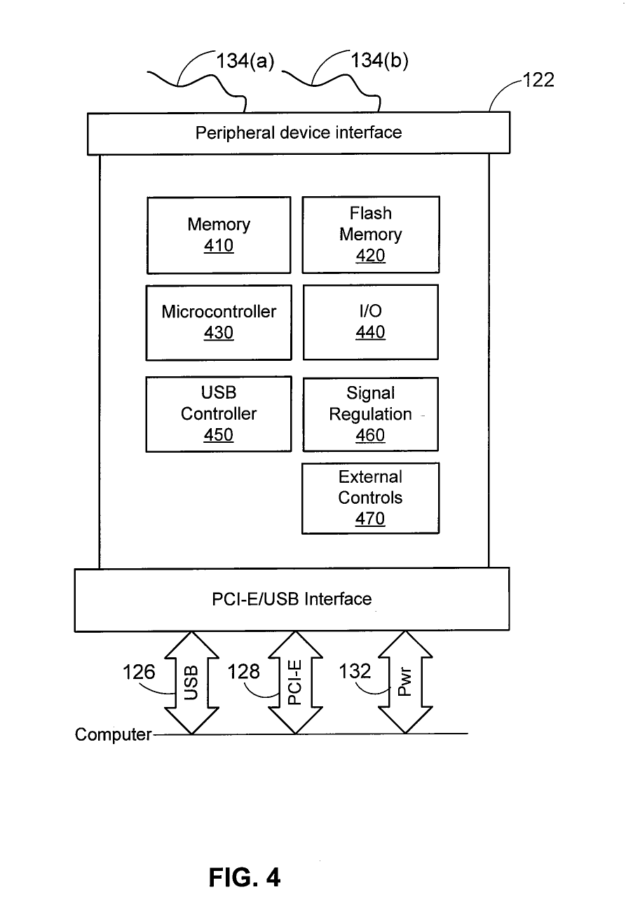

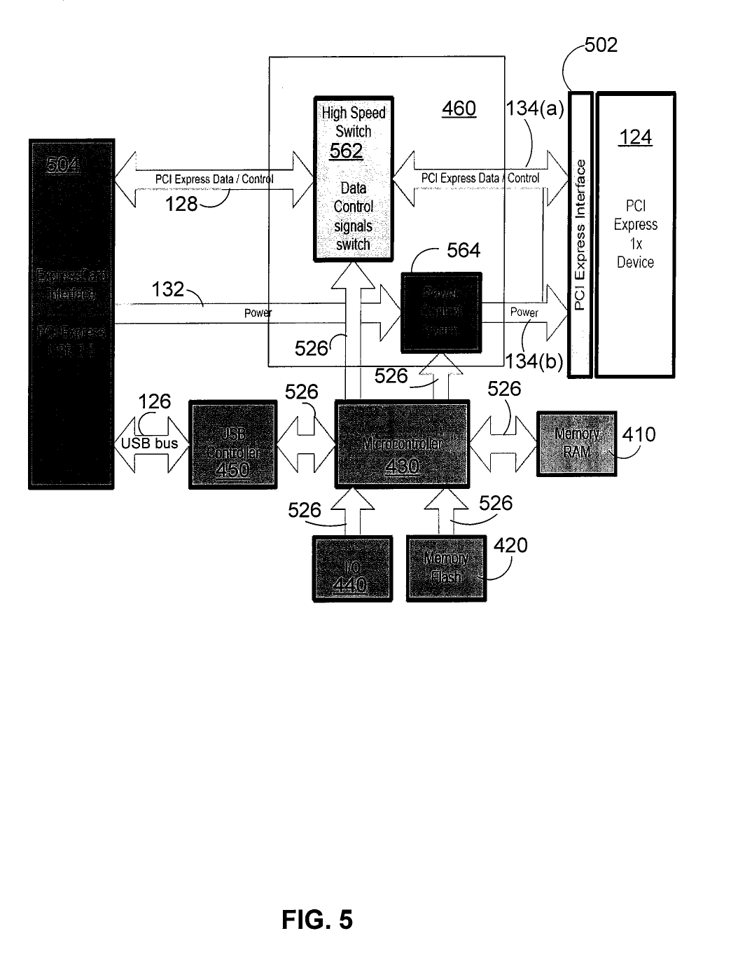

FIG. 4 is a high-level block diagram and FIG. 5 is a high-level schematic of one embodiment of peripheral component interface device 122. In one embodiment, peripheral component interface device 122 includes memory 410, flash memory 420, microcontroller 430, input/output (IO) circuit 440, USB controller 450, and a signal regulation circuit 460. Memory 410 and flash memory 420 may be any type of suitable memory. For example, memory 410 and flash memory 420 may be memory capable of storing tangible data such as audio/video files, computer programs, and the like. Any suitable combination of the components shown in FIG. 5 may be present in the peripheral component interface device 122 or may be separate therefrom.

Memory 410 and flash memory 420 may be semiconductor memories such as flash memories, ROMS, battery-backed volatile memories, networked storage devices, dynamic random access memory (DRAM), static random access memory (SDRAM), DDR memories, and the like. Such flash memory 420 may be volatile memory used for temporary storage of data, such as configuration data, data commands from computer 120, data used during the operation of peripheral component interface device 122, and the like.

Memory 410 may be used for storing data related to configurations and operation of peripheral component interface device 122. For example, the peripheral component interface device 122 data may include an initial operational state, handshake protocols, peripheral component interface device 122 model, software drivers employed by microcontroller 430 to operate the peripheral component interface device 122, and the like.

In one embodiment, microcontroller 430, USB controller 450, IO circuit 440, memory 410, flash memory, and signal regulation circuit 460 communicate over a bus 526. Bus 526 may be any suitable bus configuration capable of providing data communication between microcontroller 430, USB controller 450, IO circuit 440, memory 410, flash memory, and signal regulation circuit 460.

In embodiments of the present invention, bus 526 operatively couples the microcontroller 430 and the computer 120 with other components such as the USB controller 450. The bus 526 also operatively couples the memory 410, flash memory 420, and signal regulation circuit 460 to the microcontroller 430 In one embodiment, the signal paths formed by the bus 526 enable microcontroller 430 to receive commands from computer 120 via USB controller 450 to, for example, control the operation of signal regulation circuit 460 as described further below.

IO circuit 440 may be used to allow direct and independent communication with microcontroller 430 in lieu of and/or in cooperation with computer 120. In one embodiment, such independent control may allow a user to externally configure the peripheral component interface device 122. IO circuit 440 may allow the use of external controls, such as external controls 470, disposed on peripheral component interface device 122, to control operations of peripheral component interface device 122 and peripheral device 124 connected thereto. For example, peripheral component interface device 122 may include buttons, switches, or other suitable controls to control the brightness, contrast, focus, resolution, etc., of a peripheral monitor, operations of a printer, and the like, connected thereto. In other embodiments, such external controls may be used to operate functions that may be available from computer 120 such as operations to turn peripheral device 124 on or off, initiate a reset sequence, establish a standby mode, and the like.

In one embodiment, signal regulation circuit 460 may include a data control switch 562 and power switch 564, among other components Data control switch 562 may be any suitable data control circuit such as a data switch, a register, a multiplexer, and the like. Data control switch 562 may be configured to control the flow of data between computer 120 and peripheral device 124. For example, data control switch 562 may receive control signals from the microcontroller 430, which receives data from the USB controller 450 (which receives data from the USB bus 126), and may be used to control data transmitted between PCI express bus 128 and data path 134(a) connected to peripheral device 124 via an interface 502. In some embodiments, the PCI express bus 128, alone or with other components, may be considered a first communication bus connected to computer via an interface 504, while the USB bus 126, alone or in combination with other components may be considered a second communication bus connected to computer via interface 504, or a separate interface therefrom. Data control switch 562 may also be used as temporary data storage for use by computer 120. For example, when a peripheral device 124 is connected to an active peripheral component interface device 122, data control switch 562 may hold any communication received from peripheral device 124 for later use by computer 120.

Power switch 564 may be any suitable power control circuit such as transistor switch, operational amplifier, relay, and the like connected to power signals from the computer 120 via, for example, an interface 504. Power switch 564 may be configured to control power signals between computer 120 and peripheral device 124. For example, power switch 564 may be used to control power signals transmitted between power signal interface 132 and power path 134(b) connected to peripheral device 124 via an interface 502. In one embodiment, power switch 564 may be configured to control the power on sequence of peripheral device 124 via commands from microcontroller 430. For example, for a peripheral device 124 that requires power voltages operated in a sequential manner, power switch 564 may be used to sequentially connect power signals from computer 120 to peripheral device 124.

In one embodiment, power switch 564 may provide power regulation and/or power filtration to power signals transmitted to peripheral device 124. Such power regulation may be used to protect peripheral device 124, and may be used to initiate an operational state of peripheral device 124 responsive to such power signals. For example, for peripheral device 124 responsive to input voltage levels, a reduced voltage may induce peripheral device 124 to enter another operational mode such as a standby mode, sleep mode, and the like.

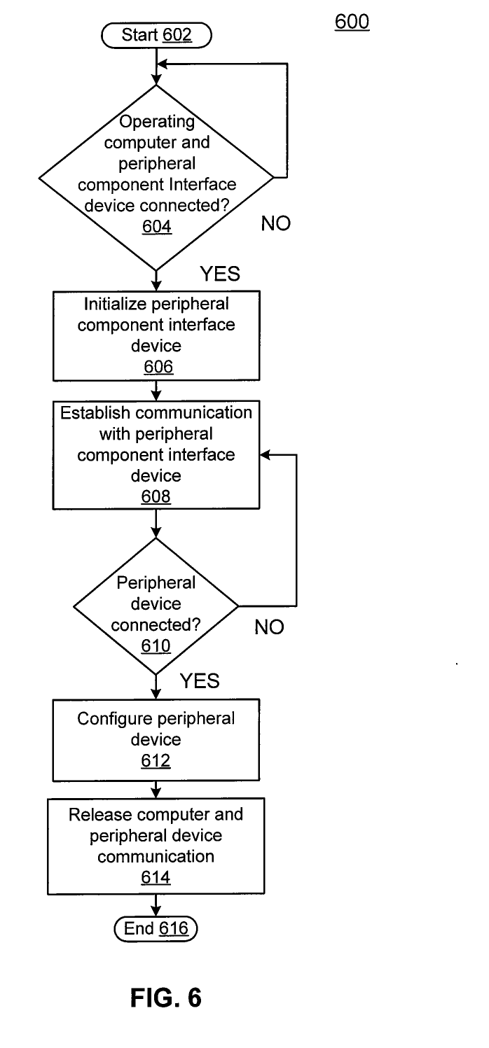

FIG. 6 is a high-level flow diagram of a method 600 of operating peripheral component interface device 122. Method 600 may be entered into, for example, at step 602 when peripheral component interface device 122 is connected to computer 120. At step 604, method 600 determines if computer 124 is operating e.g., powered on, or in an inactive state such as in a powered off state, in a wait state, standby state, sleep state, and the like. Method 600 also determines if peripheral component interface device 122 is connected to computer 120, for example by communicating with peripheral component interface device 122 over USB bus 126.

If at step 604, computer 120 is powered off, or in an inactive type mode, or peripheral component interface device 122 is not connected, method 600 waits until computer 120 is activated and peripheral component interface device 122 is connected. In one embodiment, peripheral component interface device 122 may be connected to computer 120 while computer 120 is in an off or inactive state. In another embodiment, peripheral component interface device 122 may be connected while computer 120 is in an operational state (e.g., powered on).

Once computer 120 and peripheral component interface device 122 are connected, and computer 120 is in an active state (e.g., powered on), at step 606, peripheral component interface device 122 is initialized. In one embodiment, the initialization process involves an initial communication between microcontroller 430 communicating with computer 120 over USB bus 126. For example, such an initialization process may involve the peripheral component interface device 122 and computer 120 handshaking to acknowledge each other according to handshake protocols as are known in the art.

In one embodiment, the acknowledgment process may be performed using USB controller 450 exchanging data generated by peripheral component interface device control engine 310 with microcontroller 430. In response to such data, microcontroller 430 controls data between computer 120, peripheral component interface device 122, and a connected peripheral device 124, as described below. For example, peripheral component interface device control engine 310 may provide initial operation commands to peripheral component interface device 122 via USB bus 126 instructing microcontroller 430 to set peripheral component interface device 122 to an initial operational state.

Such an initialization process in embodiments of the present invention may involve preparation of computer 120 and peripheral component interface device 122 to communicate with peripheral device 124, when connected thereto. For example, computer 120 may recognize peripheral component interface device 122 such that a user may be able to communicate with, and configure, such peripheral component interface device 122 via, for example, input device 140 with, or without, a peripheral device 124 connected to peripheral component interface device 122.

To provide for plug-and-play compatibility, such initialization process may depend on the state of computer 120 when peripheral component interface device 122 is connected thereto. For example, one initialization process may be used if peripheral component interface device 122 is connected to computer 120 when computer 120 is in a deactivated state, such as in a powered-off state, in a standby state, and the like. Another initialization process may be used if peripheral component interface device 122 is connected to computer 120 when such computer 120 is in a powered-on state.

In one embodiment, which initialization process to use may be determined through communication between computer 120 and peripheral component interface device 122. For example, if peripheral component interface device 122 is plugged into a computer 120 that is powered off, a signal from computer 120 during a boot-up stage of computer 120 may be used to initiate a cold-start initialization process between computer 120 and peripheral component interface device 122.

Alternatively, if peripheral component interface device 122 is plugged into a computer 120 that is powered on prior to plugging peripheral component interface device 122 into computer 120, a signal from I/O interface (136; see FIG. 2) communicates over USB bus 126 to initiate a hot-plug initialization process between computer 120 and peripheral component interface device 122. For example, in one embodiment, if peripheral component interface device 122 is plugged into a computer 120 that has already been powered on, signals over USB bus generated by peripheral component interface device control engine 310 may be used to operate microcontroller 430 to perform an initialization process pertaining to computer 120 being in a powered-on operational mode. In either case, the initialization process places the peripheral component interface device 122 in a mode to receive and/or communicate with peripheral device 124 connected thereto, or yet to be connected.

At step 608, computer 120 and peripheral component interface device 122 communicate to exchange user defined settings, factory settings, and the like. For example, a user may have configured peripheral component interface device 122 using configuration data 330 to a base operational state. Such base operational state may include predetermined peripheral device settings.

In one embodiment as described below, if a peripheral device 124 is not connected, such base operation state may involve commands to microcontroller 430 via USB bus 126 causing data regulation circuit 460 to interrupt data signals between interface 504 and paths 134(a) and 134(b). For example, peripheral component interface control engine 310 may provide data interrupt control signals over USB bus 126 to microcontroller 430. In response to such data interrupt control signals, microcontroller 430 may operate data regulation circuit 460 to interrupt and/or modify data signals over PCI express bus 128 and power bus 132 between interface 504 and paths 134(a) and 134(b).

In one embodiment at step 610, when a peripheral device 124 is connected to peripheral component interface device 122, such peripheral device 124 is configured, for example at step 612, using configuration data 330. Peripheral device 124 may be configured using any number of suitable methods as described below. For example, to maintain plug-and-play capability, PCI express data signals (over bus 126) and or power signals (over bus 132) may be configured to operate a peripheral device 124 that does not require a reset to operate on PCI express bus 128, or may be configured to operate a peripheral device 124 that requires a soft reboot in order to correctly communicate and operate over a PCI express bus, and the like. In other embodiments, power signals transmitted over power path 134(b) may be altered to initiate a reboot sequence of the peripheral device 124 as described further below. At step 614, peripheral device 124 and computer 120 are released to communicate via peripheral component interface device 122.

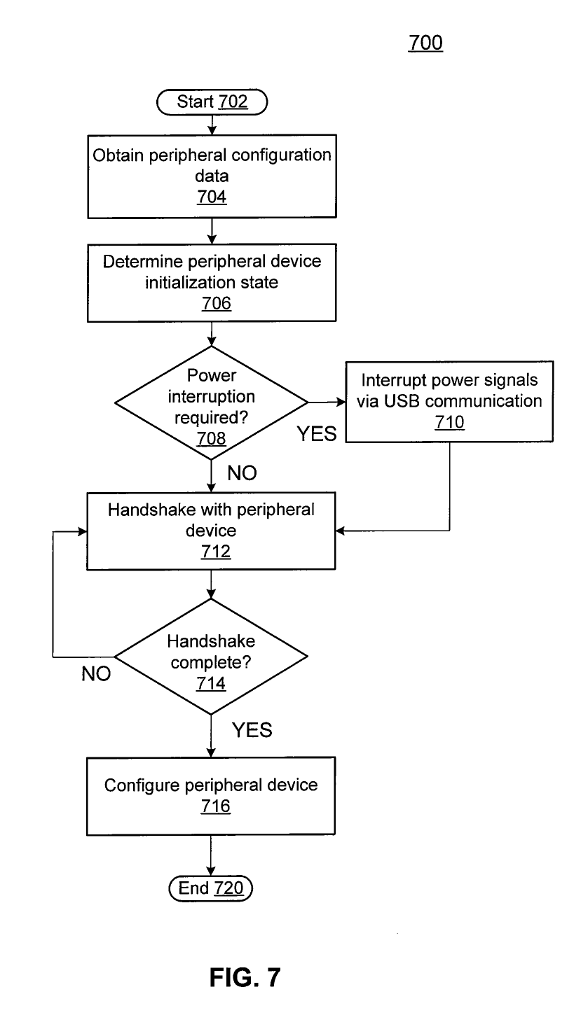

FIG. 7 is a high-level flow diagram of a method 700 of communicating with and configuring a peripheral device for example for use with step 612 above. Method 700 may be entered into at step 702, for example, when a peripheral device 124 is connected to peripheral component interface device 122. At step 704, the configuration of the peripheral device 124 is determined. The microcontroller 430 controls signals 134(a), 134(b) by accessing the data control switch 562 and the power control switch 564.

At step 706, the initialization state of peripheral device 124 is determined. In one embodiment, peripheral component interface device engine 310 determines the initial state of peripheral device 124 using peripheral data 320. For example, peripheral component interface device engine 310 may query peripheral data 320 to obtain data pertaining to the initial operational state of peripheral device 124. In another embodiment, peripheral component interface device engine 310 may query other databases such as data stored in memory 420 to determine the initial state of peripheral device 124.

The initial state of peripheral device 124 may depend on initializing peripheral device 124 from an off state, reset state, and the like. In one embodiment, if at step 708 a power interruption and/or reset signal is not required method 700 proceeds to step 712. However, if a power interruption or reset signal is required to place peripheral device 124 in an initial state, peripheral component interface device engine 310 may provide a reset and/or power commands to peripheral component interface device 122 via USB bus 126. At step 710, in response to such reset and/or power commands, microprocessor 430 may provide interrupt signals or alter power signals provided to peripheral device 124 via power path 134(b).

At step 712, peripheral component interface engine 310 provides a interface handshake command to peripheral component interface device 122 via USB bus 126. Such interface handshake command may be obtained, for example, from any suitable memory location such as memory 170. At step, 714 if the handshake is complete, then peripheral device 124 is configured at step 716. If, however, at step 716 interface handshake command is not complete, method 700 returns to step 712.

At step 716, peripheral device 124 is configured. For example, configuration data 330 may be transmitted to peripheral device 124 over data path 134(a) and/or power path 134(b) via USB bus 126, and/or via PCI express bus 128. In one embodiment, such configuration data 330 may configure peripheral device 124 to a predefined user setting, default setting, and the like. For example, with regard to a peripheral monitor, such configuration data may be used to establish a display configuration such as resolution, color, contrast, brightness, to a predefined user configuration. Method 700 ends at step 720.

Embodiments of the invention provide a number of advantages. Such advantages include the ability to control a peripheral device using a connectable peripheral component interface device. As explained above, embodiments of the invention provide better plug-and-play capability when using a high speed data bus such as a PCI Express data bus than conventional PCI Express bus interface devices. Other advantages include using one connectable peripheral component interface of the computer to control communication between a computer and a peripheral device via a second connectable peripheral component interface. Using two connectable peripheral component interfaces provides better and more controllable plug-and-play capability between the computer and the peripheral device than is available only using a conventional connectable peripheral component interface.

Any of the above described steps may be embodied as computer code on a computer readable medium. The computer readable medium may reside on one or more computational apparatuses and may use any suitable data storage technology.

Embodiments of the present invention can be implemented in the form of control logic in software or hardware or a combination of both. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A peripheral component interface device capable of being removably coupled to an input-output interface in a computer, and at least one peripheral device, the peripheral component interface device comprising:
a first communication bus configured to be removably coupled to the input-output interface associated with the computer;
a second communication bus configured to be removably coupled to the input-output interface associated with the computer; and
a signal regulation circuit electrically coupled to the first communication bus and the second communication bus, wherein the signal regulation circuit is responsive to commands from the second communication bus to control a signal from the first communication bus passing to the at least one peripheral device, when the at least one peripheral device is coupled to the peripheral component interface device.

2. The device of claim 1, wherein the first communication bus comprises a PCI Express bus.

3. The device of claim 1, wherein the second communication bus comprises a universal serial bus.

4. The device of claim 1, wherein the signal regulation circuit comprises a high speed switch.

5. The device of claim 1, further comprising a USB controller configured to communicate with the computer over the second communication bus, and wherein the input output interface comprises a peripheral component interconnect interface and a universal serial bus interface.

6. The device of claim 1, further comprising a microcontroller, wherein the microcontroller is coupled to and receives data from the second communication bus, and wherein the microcontroller is also coupled to and sends control data to the signal regulation circuit.

7. The device of claim 6, further comprising a power bus and a power control switch, wherein the power control switch is part of the signal regulation circuit and wherein the microcontroller receives signals from the input output interface and sends signals to the power control switch to control a power signal from the power bus passing to the at least one peripheral device.

8. A method of establishing communication between an input output interface in a computer and at least one peripheral device using a peripheral component interface device comprising a first communication bus, a second communication bus, and a signal regulation circuit operatively coupled to the first communication bus and the second communication bus, the method comprising;
coupling the peripheral component interface device to the computer and the at least one peripheral device; and
receiving a first signal from the first communication bus and a second signal from the second communication bus, and controlling the first signal from the first communication bus using the second signal from the second communication bus and the signal regulation circuit to establish a third signal which passes to the at least one peripheral device.

9. The method of claim 8, wherein the third signal is used to establish an operational configuration between the computer and the at least one peripheral device.

10. The method of claim 8, wherein the first communication bus comprises a peripheral component interface bus.

11. The method of claim 8, wherein the second communication bus comprises a universal serial bus.

12. The method of claim 8, wherein the peripheral component interface device is removably coupled to an input output interface in the computer and the at least one peripheral device using cables.

13. The method of claim 8, further comprising receiving a power signal from the computer at the signal regulation circuit, and then controlling the power signal using the signal regulation circuit.

14. The method of claim 8, further comprising interrogating the at least one peripheral device to determine the initial operating configuration of the peripheral device.

15. A system for establishing communication between a computer and at least one peripheral device, the system comprising:
a processor:
a computer readable storage medium coupled to the processor, wherein the computer readable storage medium includes:
code for determining an initial configuration of the at least one peripheral device connected to the computer with respect to an operational state of the computer; and
code for modifying a first signal from a first communication bus using a second signal from a second communication bus to produce a third signal capable of controlling the at least one peripheral device using a signal regulation circuit.

16. The system of claim 15, wherein the processor and the computer readable storage medium form part of a peripheral computer interface device, and wherein the system includes the computer and the at least one peripheral device removably connected to the peripheral computer interface device.

17. The system of claim 15, wherein the first communication bus comprises a peripheral component interconnect bus.

18. The system of claim 15, wherein the second communication bus comprises a universal serial bus.

19. The system of claim 15, further comprising a power bus operatively coupled to the signal regulation circuit.

20. The system of claim 19, further comprising a power control switch operatively coupled to the power bus.
